(19) United States
(12) Patent Application Publication
(10) Pub. No.: US 2014/0108451 A1
(43) Pub. Date: Apr. 17, 2014

(54) METHOD AND APPARATUS FOR INTEGRATED APPLICATION SEARCH IN MULTIPLE APP STORES

(71) Applicant: ELECTRONICS AND TELECOMMUNICATIONS RESEARCH INSTITUTE, Daejeon (KR)

(72) Inventors: Sang Yun LEE, Daejeon (KR); Tae Gun KANG, Daejeon (KR); Seung Chul KIM, Daejeon (KR); In Cheol JEONG, Daejeon (KR); Seung Hee KIM, Daejeon (KR); Sang Taick PARK, Seoul (KR); Jin Woo HONG, Daejeon (KR)

(73) Assignee: ELECTRONICS AND TELECOMMUNICATIONS RESEARCH INSTITUTE, Daejeon (KR)

(21) Appl. No.: 14/052,502

(22) Filed: Oct. 11, 2013

(30) Foreign Application Priority Data
Oct. 11, 2012 (KR) 10-2012-0112880
Jun. 25, 2013 (KR) 10-2013-0073167

(51) Int. Cl. G06F 17/30

(52) U.S. Cl. CPC G06F 17/30864
USPC 707/770

(57) ABSTRACT

An application search apparatus is provided, the apparatus including an input unit to receive a search word from a user, and generate a query word based on the received search word, a controller to provide an integrated result of searching a plurality of app stores for an application corresponding to the query word, and a storage unit to categorize an application provided by the plurality of app stores, and download and store the application provided by the plurality of app stores.

### CROSS-REFERENCE TO RELATED APPLICATIONS

This application claims the benefit of Korean Patent Application No. 10-2012-0112880, filed on Oct. 11, 2012, and Korean Patent Application No. 10-2013-0073167, filed on Jun. 25, 2013, in the Korean Intellectual Property Office, the disclosures of which are incorporated herein by reference.

### BACKGROUND

1. Field of the Invention

The present invention relates to an apparatus and method for searching for an application, and more particularly, to an apparatus and method for searching for an application stored in an integrated app store and an app stored in another app store, with a single search through the integrated app store.

2. Description of the Related Art

With the recent introduction of smart phones, a process of downloading an application from an app store has been generalized. In addition, app store services are currently being provided by terminal manufacturers, portal service providers, smart television (TV) manufacturers, automobile manufacturers, and the like.

A user may use an app store client installed in a terminal to download an application, or may download a separate app store client for accessing a third-party app store to download an application.

Since applications are distributed to and provided via multiple app stores, duplicate applications may be stored and thus, the user may be required to expend a greater amount of time and effort than before to acquire a desired application.

Accordingly, there is a demand for an application search apparatus and method that may search for an application desired by a user through a single search, irrespective of an app store, rather than searching through multiple app stores individually for an application provided by an app store.

### SUMMARY

According to an aspect of the present invention, there is provided an application search apparatus including an input unit to receive a search word from a user, and generate a query word based on the received search word, and a controller to provide an integrated result of searching a plurality of app stores for an application corresponding to the query word.

The controller may include a search unit to search at least one of the plurality of app stores for an application corresponding to the query word, a distributor to distribute the query word to the plurality of app stores, and an integrated processor to generate the integrated result, by integrating results of searching the plurality of app stores for the application corresponding to the query word.

The apparatus may further include a storage unit to categorize an application provided by the plurality of app stores.

The storage unit may download and store the application provided by the plurality of app stores.

When the application corresponding to the query word is found in the storage unit, the application may be provided to the user.

When the application corresponding to the query word is not found in the storage unit, the controller may control the application search apparatus to interoperate with the plurality of app stores.

The apparatus may further include a communication unit to interwork with the plurality of app stores and provide an interface to receive the integrated result.

The application search apparatus may further include a provider to provide the user with the integrated result.

According to another aspect of the present invention, there is also provided an application search server including a generator to generate a query word based on a search word input by a user, an interoperating unit to interoperate with a plurality of app stores for communication, a search unit to register or search at least one of the plurality of app stores based on the query word, and an integrated processor to provide an integrated result of searching for an application corresponding to the query word, by integrating results of searching the plurality of app stores for the application.

The server may further include a distributor to distribute the query word to the plurality of interoperating app stores.

According to still another aspect of the present invention, there is also provided an application search method including receiving a search word from a user, and generating a query word based on the search word, verifying whether an application corresponding to the query word is present on an application server, interoperating with a plurality of app stores when the application corresponding to the query is absent on the application server, searching the plurality of app stores for the application corresponding to the query word, and providing an integrated result of searching for the application corresponding to the query word, by integrating results of searching the plurality of app stores for the application.

The application corresponding to the query word may be provided to the user when the application corresponding to the query word is present on the application server.

The method may further include verifying whether an application corresponding to the search word of the user is present in the integrated result.

When the application corresponding to the search word of the user is present in the integrated result, the application corresponding to the search word may be provided to the user. When the application corresponding to the search word of the user is absent in the integrated result, the application search method may be re-performed, starting from the generating.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an apparatus for searching for an application in an integrated app store according to an embodiment;

FIG. 2 is a block diagram illustrating a controller included in an application search apparatus according to an embodiment;

FIG. 3 is a block diagram illustrating a process of searching for an application according to an embodiment;

FIG. 4 is a diagram illustrating a configuration of an apparatus for searching for an application in an integrated app store according to an embodiment;

FIG. 5 is a table illustrating open application programming interfaces (APIs) provided for an interoperation with a plurality of app stores in an application search apparatus according to an embodiment;

FIG. 6 is a flowchart illustrating a method of searching for an application in an integrated app store according to an embodiment.

### DETAILED DESCRIPTION

Reference will now be made in detail to exemplary embodiments of the present invention with reference to the accompanying drawings. However, the present invention is not limited to the exemplary embodiments. In the accompanying drawings, like reference numerals refer to the like elements throughout.

The terms used herein are mainly selected from general terms currently being used in light of functions in the present invention. Yet, the meanings of the terms used herein may be changed to keep up with the intent of an operator in the art, a custom, or the appearance of new technologies.

In addition, in a specific case, most appropriate terms are arbitrarily selected by the applicant for ease of description and/or for ease of understanding. In this instance, the meanings of the arbitrarily used terms will be clearly explained in the corresponding description. Hence, the terms should be understood not by the simple names of the terms but by the meanings of the terms and the following overall description of this specification.

A user using an electronic device capable of communication, for example, a terminal such as a smart phone and a smart television (TV), may download a desired application using an app store client installed in the electronic device. In addition, the user may download a separate app store client for accessing a third-party app store to download the desired application.

Since the application may be distributed to various app stores, and duplicate applications may be stored in an identical application store, the user may expend a relatively greater amount of time and efforts to search for the desired application.

Accordingly, in order to overcome such issues, an application search apparatus and method using an integrated app store linked to a plurality of app stores may be provided. In addition, an application search apparatus and method that may simultaneously search for an application included in the integrated app store and an application included in another app store interoperating with the integrated app store, through a single input of a search word.

As used herein, the term “app store” is an abbreviation of application store which refers to an online mobile contents marketplace in which mobile applications are bought and sold freely. In addition, the “app store” may refer to an online space in which external developers may develop and release various services, such as games, based on a service infrastructure and a platform provided by an enterprise, and the general public may search for, select, and use such services.

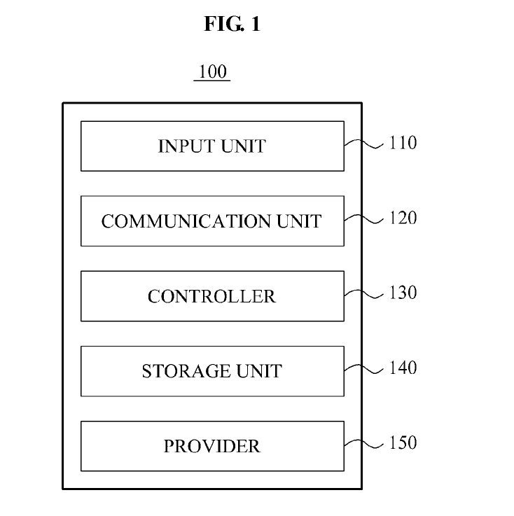

FIG. 1 is a block diagram illustrating an apparatus 100 for searching for an application in an integrated app store according to an embodiment.

Referring to FIG. 1, the application search apparatus 100 may include an input unit 110, a communication unit 120, a controller 130, a storage unit 140, and a provider 150.

The input unit 110 may receive a search word provided by a user, and generate a query word based on the received search word.

The controller 130 may provide an integrated result of searching a plurality of app stores for an application corresponding to the query word.

The storage unit 140 may categorize an application provided by the plurality of app stores, and download and store the provided application.

When the search word is input by the user, the query word may be generated based on the search word, and verification as to whether the application corresponding to the query word, for example, an application desired by the user, is present in the storage unit 140 may be performed.

When the desired application is present in the storage unit 140, the provider 150 may provide the corresponding application to the user.

Conversely, when the desired application is absent in the storage unit 140, the controller 130 may initiate an interoperation with the plurality of app stores through the communication unit 120.

The communication unit 120 may enable the application search apparatus 100 to interoperate with the plurality of app stores. In addition, the communication unit 120 may provide an interface to receive the integrated result of searching for the application corresponding to the query word from the plurality of app stores.

An apparatus and method for searching a plurality of app stores for an application corresponding to a query word generated based on a search word input by a user, by the controller 130 will be described in detail hereinafter.

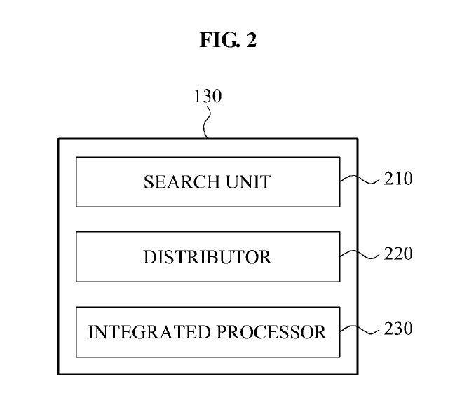

FIG. 2 is a block diagram illustrating the controller 130 included in the application search apparatus 100 of FIG. 1.

As described above, when an application desired by a user, for example, an application desired to be found, is stored in the storage unit 140 of the application search apparatus 100, the provider 150 may provide the corresponding application directly to the user.

However, when the desired application is not stored in the storage unit 140, the controller 130 may initiate an interoperation with a plurality of app stores to search for the desired application.

The controller 130 may include a search unit 210, a distributor 220, and an integrated processor 230.

The search unit 210 may search at least one of the plurality of app stores associated with the application search apparatus 100 for the application desired by the user based on a query word.

The distributor 220 may distribute the query word to the plurality of app stores interoperating with the application search apparatus 100.

The integrated processor 230 may generate an integrated result of searching for an application corresponding to the query word, by integrating results of searching the plurality of app stores for the application.

The integrated result may be provided to the user by the provider 150 of the application search apparatus 100. Accordingly, the user may receive the integrated result from the plurality of app stores associated with the application search apparatus 100, through a single input of a search word.

When the desired application is present in the integrated result of searching for the application, the user may download and use the corresponding application.

Conversely, when the desired application is absent in the integrated result of searching for the application, a process of searching the plurality of app stores associated with the application search apparatus 100 and the storage unit 140 of the application search apparatus 100 for the application may be re-performed.

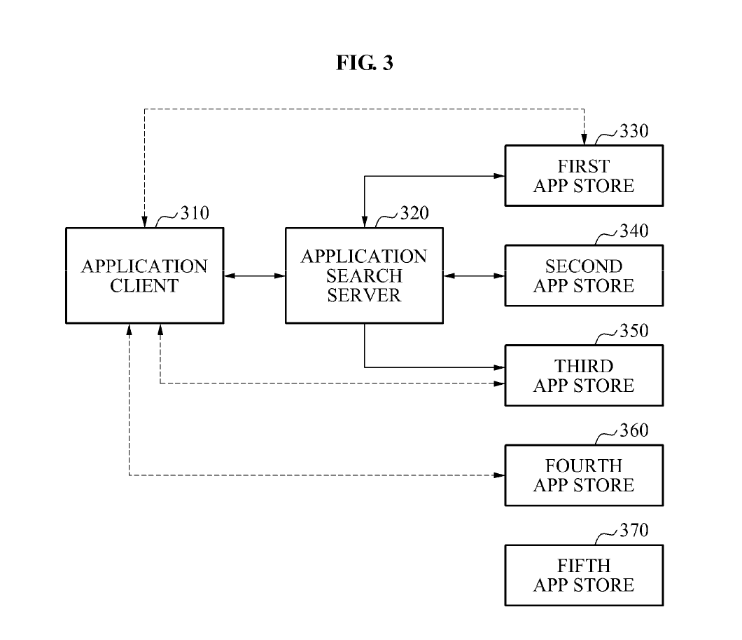

FIG. 3 is a block diagram illustrating a process of searching for an application according to an embodiment.

In order to search for an application desired by a user, an app store client 310 may be installed in a terminal or a smart device, for example, a smart phone, a smart pad, and a smart television (TV), used by the user.

The app store client 310 may provide a function to search for the desired application.

In addition, in order to search for the desired application, an application search server 320 in which autonomously serviced applications are included in a storage unit, or the application search apparatus 100 of FIG. 1 may be provided.

The application search server 320 may include the autonomously serviced applications, and also search for the desired application by interoperating with a plurality of separate app stores 330, 340, 350, 360, and 370 associated with the application search server 320.

The plurality of app stores 330, 340, 350, 360, and 370 may correspond to various types of app stores, each providing a service for searching for an application and downloading a found application.

The app store client 310 may include an app store difficult to access, for example, the app store 370, among the plurality of app stores 330, 340, 350, 360, and 370. In addition, the app store client 310 may include app stores 330, 340, 350, and 360 to be connected to the app store client 310 through the application search server 320, or to be connected directly to the app store client 310 without the application server 320.

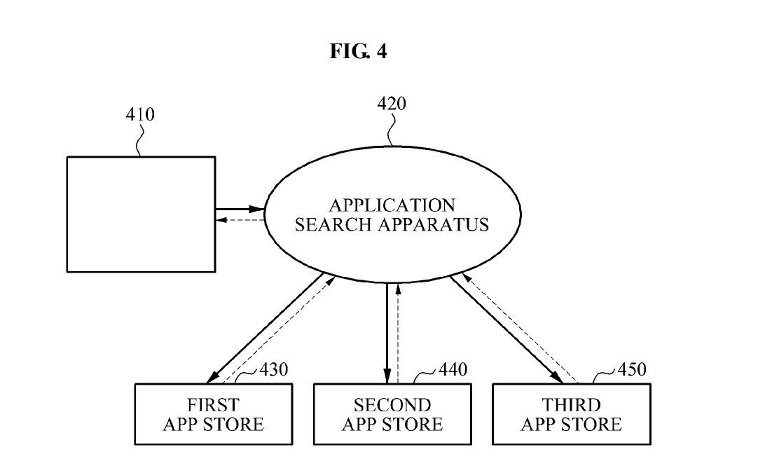

FIG. 4 is a diagram illustrating a configuration of an apparatus 420 for searching for an application in an integrated app store according to an embodiment.

FIG. 4 illustrates an example of searching for an application desired by a user using the application search apparatus 420 or an application search server.

The user may search for the desired application through an app store client 410 corresponding to a smart device, for example, a smart phone, and a smart TV.

The application search apparatus 420 or the application search server may be connected to or interoperate with a first app store 430, a second app store 440, and a third app store 450.

Each of the first app store 430, the second app store 440, and the third app store 450 may provide a service associated with an application.

The application search apparatus 420 may transfer a query word corresponding to a search word input by the user to the first app store 430, the second app store 440, and the third app store 450, and receive a result of a search conducted for the desired application.

The user may select the desired application in the result of the search conducted for the application, and download the application to the smart device, for example, the smart phone, and the smart TV.

Accordingly, the user may receive an integrated result, without searching the plurality of app stores individually for the application, and inputting a search word associated with an app store to be searched by the user into each of the plurality of app stores.

As described above, the user may not conduct a number of searches and receive results of the number of searches conducted. When the user provides a single input of a search word into the application search apparatus 420 or the application search server, the application search apparatus 420 may integrate results of searching the plurality of app stores for the application, and provide an integrated result.

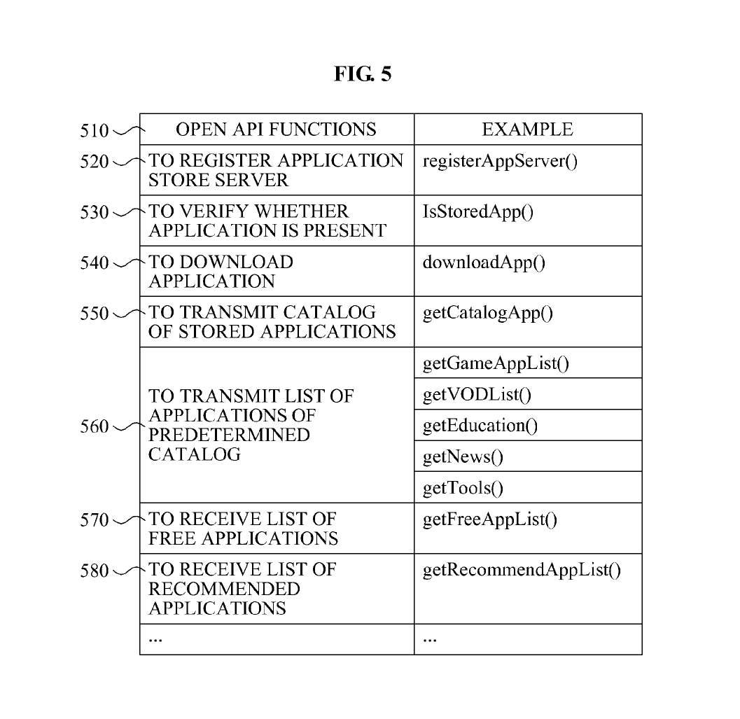

FIG. 5 is a table illustrating open application programming interfaces (APIs) provided for an interoperation with a plurality of app stores in an application search apparatus according to an embodiment.

The application search apparatus or an application search server may interoperate with a plurality of app stores, by calling predefined APIs 510, for example, an API 520 to register an app store server, an API 530 to verify whether an application is present, an API 540 to download an application, an API 550 to transmit a catalog of stored applications, an API 560 to transmit a list of applications of a predetermined catalog, an API 570 to receive a list of free applications, an API 580 to receive a list of recommended applications, and the like.

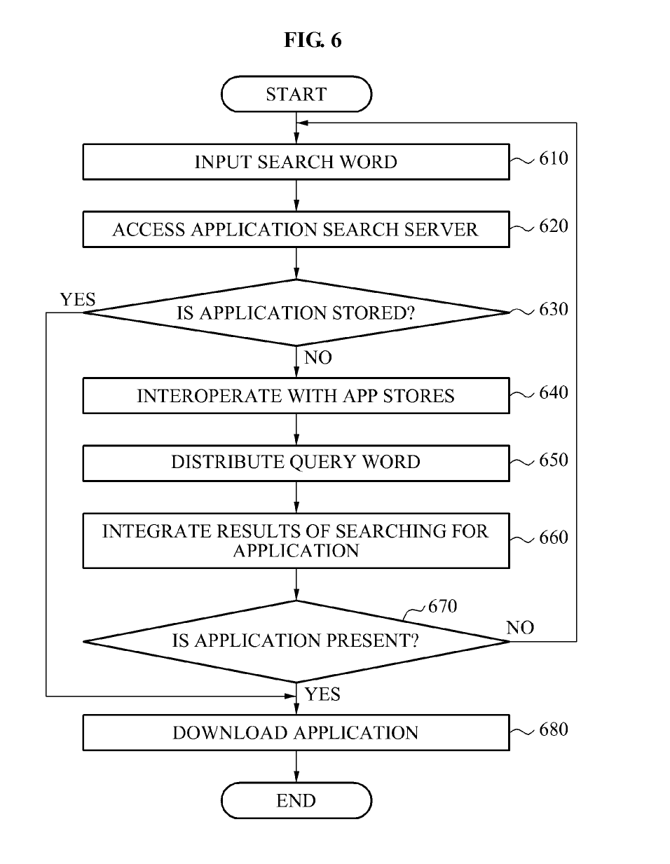

FIG. 6 is a flowchart illustrating a method of searching for an application in an integrated app store according to an embodiment.

Referring to FIG. 6, a search word with respect to an application desired by a user may be input into an app store client, in operation 610. In operation 620, the app store client may access an application search apparatus.

A query word may be generated based on the input search word, and whether an application corresponding to the query word, for example, the application desired by the user, is stored in a storage unit of the application search apparatus may be verified, in operation 630.

When the desired application is stored in the storage unit, the application may be downloaded by the user, in operation 680.

Conversely, when the desired application is not stored in the storage unit, an interoperation with a plurality of app stores may be performed, in operation 640.

When the application search apparatus interoperates with the plurality of app stores, the query word associated with the application may be distributed to the plurality of interworking app stores, in operation 650.

Results of searching the plurality of interworking app stores for the application corresponding to the query word may be received, and the received results may be integrated, in operation 660.

An integrated result may be provided to the user, and whether the desired application is present in the integrated result may be verified, in operation 670.

When the desired application is present in the integrated result, the corresponding application may be downloaded, in operation 680.

Conversely, when the desired application is absent in the integrated result, a new search word may be input to conduct a search using the application search method.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more non-transitory computer readable recording mediums.

The method according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An application search apparatus comprising:
an input unit to receive a search word from a user, and generate a query word based on the received search word; and
a controller to provide an integrated result of searching a plurality of app stores for an application corresponding to on the query word.

2. The apparatus of claim 1, wherein the controller comprises:
a search unit to search at least one of the plurality of app stores for an application corresponding to the query word;
a distributor to distribute the query word to the plurality of app stores; and
an integrated processor to generate the integrated result, by integrating results of searching the plurality of app stores for the application corresponding to the query word.

3. The apparatus of claim 2, wherein the search unit registers and manages at least one of the plurality of app stores.

4. The apparatus of claim 1, further comprising:
a storage unit to categorize an application provided by the plurality of app stores.

5. The apparatus of claim 4, wherein the storage unit downloads and stores the application provided by the plurality of app stores.

6. The apparatus of claim 5, further comprising:
a provider to provide the application corresponding to the query word to the user when the application corresponding to the query word is stored in the storage unit.

7. The apparatus of claim 6, wherein, when the application corresponding to the query word is not stored in the storage unit, the controller controls the application search apparatus to interoperate with the plurality of app stores.

8. The apparatus of claim 1, further comprising:
a communication unit to enable the application search apparatus to interwork with the plurality of app stores, and provide an interface to receive the integrated result.

9. The apparatus of claim 6, wherein the provider provides the user with the integrated result.

10. An application search server comprising:
a generator to generate a query word based on a search word input by a user;
an interoperating unit to interoperate with a plurality of app stores for communication;
a search unit to register or search at least one of the plurality of app stores based on the query word; and
an integrated processor to provide an integrated result of searching for an application corresponding to the query word, by integrating results of searching the plurality of app stores for the application.

11. The server of claim 10, further comprising:
a distributor to distribute the query word to the plurality of interoperating app stores.

12. An application search method comprising:
receiving a search word from a user, and generating a query word based on the search word;
verifying whether an application corresponding to the query word is present on an application server;
interoperating with a plurality of app stores when the application corresponding to the query is absent on the application server;
searching the plurality of app stores for the application corresponding to the query word; and
providing an integrated result of searching for the application corresponding to the query word, by integrating results of searching the plurality of app stores for the application.

13. The method of claim 12, wherein the application corresponding to the query word is provided to the user when the application corresponding to the query word is present on the application server.

14. The method of claim 12, further comprising:
verifying whether an application corresponding to the search word of the user is present in the integrated result.

15. The method of claim 14, wherein:
when the application corresponding to the search word of the user is present in the integrated result, the application corresponding to the search word is provided to the user, and
when the application corresponding to the search word of the user is absent in the integrated result, the generating, the verifying, the interoperating, and the searching are re-performed.
